(19) United States
(12) Patent Application Publication
(10) Pub. No.: US 2021/0133901 A1
(43) Pub. Date: May 6, 2021

(54) APPARATUSES, SYSTEMS, AND METHODS FOR DETERMINING CLASSIFICATION OF A TANGIBLE PROPERTY EXPENDITURE

(71) Applicant: Eric P. Wallace, Pittsburgh, PA (US)

(72) Inventor: Eric P. Wallace, Pittsburgh, PA (US)

(21) Appl. No.: 16/671,112

(22) Filed: Oct. 31, 2019

(51) Int. Cl. G06Q 50/16; G06Q 30/02

(52) U.S. Cl. CPC G06Q 50/163; G06Q 30/0278; G06Q 50/165

(57) ABSTRACT

A system, apparatus, and method for classifying a tangible property expenditure. The method includes receiving a value of the improved portion of the building prior to the improvement being made, receiving a value of the improvement made, and determining whether the improvement was a maintenance and repair expense or a capital expenditure based on the value of the improved portion of the building before the expenditure was made and the value of the improvement made.

### CROSS-REFERENCE TO RELATED APPLICATIONS

None.

### FIELD OF THE INVENTION

The present invention is concerned with determining the classification of a tangible property expenditure and, particularly, with determining whether a real or other tangible property expenditure is a capital expenditure or an expense.

### BACKGROUND OF THE INVENTION

For a long time, different parties have inconsistently determined whether a real property expenditure was an expense or a capital expenditure. Often, two parties would decide that a similar expenditure fell into opposite categories. For example, one party might replace substantially all of a roof and categorize that expenditure as a roof replacement and as capital expenditure, while another party might categorize that expenditure as a roof repair and a deductible repair.

There is a need for a more precise method that may be used to determine whether a real or other tangible property expenditure is an expense or a capital expenditure to create consistency in that determination across a wide variety of parties.

Accordingly, there is a need for an apparatus, system and method for determining whether a real property expenditure is an expense or a capital expenditure.

### SUMMARY OF THE INVENTION

Embodiments for determining whether a tangible property expenditure, such as a real property expenditure, is an expense or a capital expenditure are directed to systems, methods and apparatuses for standardizing information and applying that standardized information to actual expenditures to determine whether those real property expenditures are expenses or capital expenditures.

Embodiments of the present apparatuses, systems and methods for determining whether tangible property expenditures are expenses or capital expenditures may each determine a building market in which the expenditure took place, collect information about the expenditure made and the extent and value of an addition made or a replacement made, apply that expenditure information to the building market, and apply that expenditure information to a standard to determine whether the expenditure is an expense or a capital expenditure.

In accordance with one embodiment, a tangible property expenditure classification system includes a camera or scanner for capturing an image of the tangible property, such as a photograph or a scan, from which to determine at least one characteristic of the property such as, for example, the dimensions of the tangible property, a data storage device to store the image and characteristics of the tangible property, to store the value of the improved portion of the building prior to the improvement being made, the value of the improvement made, and the determination of whether the tangible property expenditure is an expense or a capital expenditure, and a processor coupled to the data storage device. The processor includes instructions which, when executed by the processor, cause the processor to: receive the image of the tangible property, receive a value of the improved portion of the building prior to the improvement being made, receive a value of the improvement made, determine whether the improvement was a maintenance and repair expense or a capital expenditure based on the value of the improved portion of the building before the expenditure was made and the value of the improvement made, and store the value of the improved portion of the building prior to the improvement being made, the value of the improvement made, and the determination of whether the tangible property expenditure is an expense or a capital expenditure in the data storage device.

Another embodiment of the tangible property expenditure classification system includes: a data storage device to store data related to the tangible property, to store data related to an expenditure for an improvement made to a portion of the tangible property, to store data related to at least one of a comparable building component and building system, to store a determination of which of an expense and a capital expenditure is an appropriate classification for the expenditure for the tangible property, and to store data on which that determination is based. The system also includes a processor coupled to the data storage device, the processor including instructions which, when executed by the processor, cause the processor to: capture data on an at least one of a building component and a building system that is comparable to the improved portion for which the expenditure was made, determine a value of one of the comparable building component and the comparable building system, scale a scope of the at least one comparable building component and comparable building system to a scope of one of the building component and the building system prior to the expenditure for improvement of the tangible property, determine the value of one of the building component and the building system for which the expenditure was made prior to the improvement being made, provide an output representing the value of the improved portion prior to the expenditure being made to a human user, store the value of the improved portion prior to the expenditure being made in the data storage device, determine whether the improvement was a maintenance and repair expense or a capital expenditure based on the value of the improved portion before the expenditure was made and the value of the expenditure, and store the determination of whether the tangible property expenditure is an expense or a capital expenditure in the data storage device.

A method of tangible property expenditure classification includes: receiving a value of the improved portion of the building prior to the improvement being made, receiving a value of the improvement made, and determining whether the improvement was a maintenance and repair expense or a capital expenditure based on the value of the improved portion of the building before the expenditure was made and the value of the improvement made.

Other embodiments, which may include one or more parts of the aforementioned apparatuses, methods or systems or other parts, are also contemplated, and may thus have a broader or different scope than the aforementioned method and systems. Thus, the embodiments in this Summary of the Invention are mere examples, and are not intended to limit or define the scope of the invention or claims.

### BRIEF DESCRIPTION OF THE DRAWINGS

The accompanying drawings, which are incorporated herein and constitute part of this specification, include one or more embodiments of the invention, and together with a general description given above and a detailed description given below, serve to disclose principles of embodiments of apparatuses, systems, and methods for determining whether a tangible property expenditure is an expense or a capital expenditure.

FIG. 1 illustrates an embodiment of a method for determining a classification of a tangible property expenditure;

FIG. 2 illustrates an embodiment of a method for determination of units of property;

FIG. 3a illustrates an embodiment of a method for determining whether an expenditure made on land is a capital expenditure or a maintenance and repair expenditure;

FIG. 3b is a flowchart of a method for determining whether an expenditure made on a building is a capital expenditure or a maintenance and repair expenditure.

FIG. 4 illustrates an embodiment of a tangible property classification method that determines whether a building or land improvement is a capital expenditure or a maintenance and repair expenditure;

FIG. 5 illustrates an embodiment of a tangible property expenditure classification method or part thereof;

FIG. 6 illustrates an embodiment of a computerized system that may be employed in a tangible property expenditure system or method; and

FIG. 7 illustrates an embodiment of a network in which the computerized system of FIG. 6 may operate.

### DETAILED DESCRIPTION OF THE INVENTION

Reference will now be made to embodiments of apparatuses, systems, and methods for determining real property characteristics, examples of which include whether tangible property expenditures are expenses or capital expenditures, and are illustrated in the accompanying drawings. Details, features, and advantages of those apparatuses, systems, and methods for determining real property characteristics will become further apparent in the following detailed description of embodiments thereof. It is to be understood that the figures and descriptions included herein illustrate and describe elements that are of particular relevance to apparatuses, systems, and methods for determining real property characteristics, while eliminating, for purposes of clarity, other elements found in typical computerized systems.

Any reference in the specification to “one embodiment,” “a certain embodiment,” or any other reference to an embodiment is intended to indicate that a particular feature, structure or characteristic described in connection with the embodiment is included in at least one embodiment and may be utilized in other embodiments as well. Moreover, the appearances of such terms in various places in the specification are not necessarily all referring to the same embodiment. References to “or” are furthermore intended as inclusive so “or” may indicate one or another of the ored terms or more than one ored term.

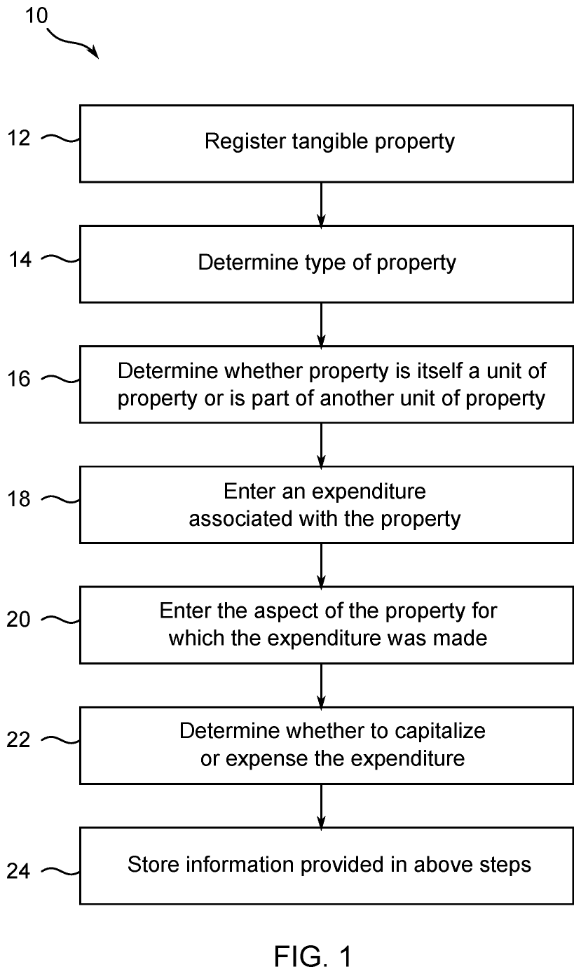

FIG. 1 is a flowchart illustrating a method for determining a classification of a tangible property expenditure 10. Embodiments of the method 10 collect information about an expenditure made and the extent and value of an addition made or a replacement made by way of that expenditure. The method 10 may then apply that expenditure information to the building market and to a predetermined standard to determine whether the expenditure is an expense or a capital expenditure.

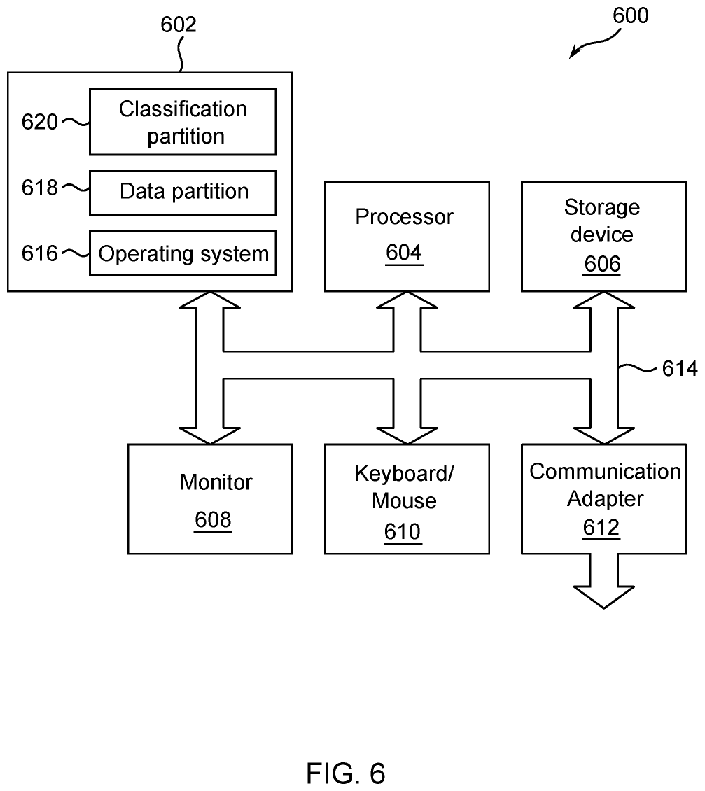

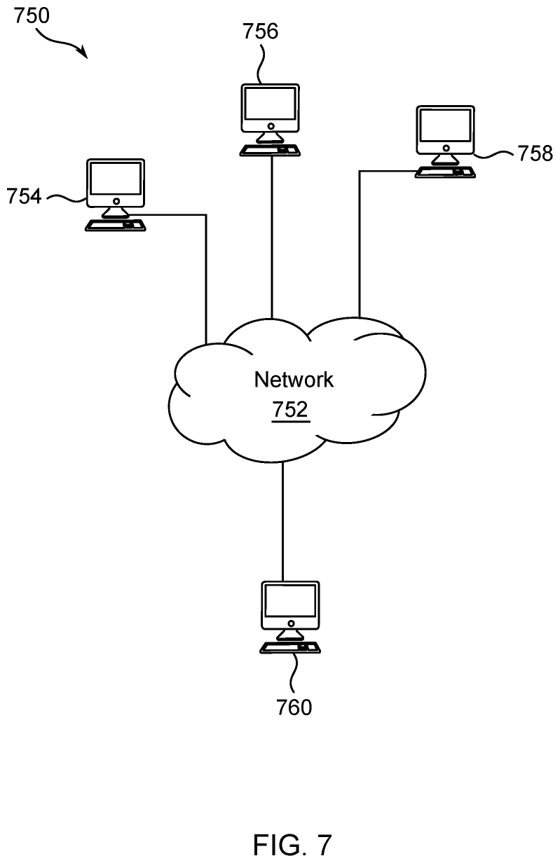

The method 10 may be performed by a computerized system, such as the computerized system 600 embodiment provided and discussed below with respect to FIG. 6 or another computerized system. In an embodiment, the computerized system 600 may include or operate with a network, such as the cloud or the network 750 discussed below with respect to FIG. 7. Thus, for example, the system 600 may perform the method 10 by way of a processor 604 that executes instructions which, when executed by the processor 604, cause the processor to performs the method 10. A data storage device 606 may be coupled to the processor 604 and may store data provided in the method 10, for example, data related to tangible property, expenditures for the tangible property, and whether the tangible property expenditure is an expense or capital expenditure. The data storage device 606 may also store the data on which the determination of whether the tangible property expenditure is an expense or capital expenditure is based. Recorded and evaluated information such as tangible property information used by the method 10 and its corresponding system 600 herein may be based on information entered into the system 600 by one or more users.

In the method 10, the tangible property is registered at 12. The type of property is determined at 14. A determination of whether the property under consideration is itself a unit of property or is part of another unit of property is made at 16. An expenditure associated with the property is entered into the system at 18 and the aspect of the property for which the expenditure was made is entered into the system at 20. The system determines whether to capitalize or expense the expenditure at 22. At 24, the aforementioned building or other tangible property information provided at 12, 14, and 16, the expenditure information provided at 18 and 20, the classification or tax treatment of the expenditure determined at 22 and a reason for that classification are memorialized by the system and stored by the system, such as the computerized system 600 or another system.

Property registration 12 may include a legal description of the tangible property, an address for the property, one or more images, photographs, designs, or plans of the tangible property, another property descriptor, and/or any other data related to the tangible property. The images, photographs, designs, or plans may include pictures or scans related to the property before and after an improvement is made and may include images, photographs, designs, or plans created or captured during the improvement work to show what was involved in the improvement.

The property type 14 may be industrial, commercial, residential, multi-use, or land. The property type may furthermore be new construction, an existing property such as one purchased after it was built and was possibly occupied prior to its purchase, or a leasehold in which, for example, the property is leased and the lessor or lessee makes an expenditure on the leased property.

Industrial property may include property used for manufacturing, energy extraction, or power generation, for example. Commercial property may include property used for hotels, offices, warehouses restaurants, and retail stores, for example. Residential property may include apartments, duplexes, single family, townhomes, condos, assisted living facilities, and prisons, for example.

Tenant-operated property may include all or a portion of a property. Tenant operated property may have a variety of uses, such as professional, retail, and hotel. The portion of a property operated by a tenant may also be relevant to the property type.

More than one property type may be applicable to a single property. For example, the property type may include one or more buildings and land, for example where land is considered a separate unit of property from any buildings resting thereon.

A partial asset disposition occurs where a capital expenditure is made, a building component or building system is replaced, and there is remaining depreciation on the replaced building component or building system. Where a building component or building system that has not been fully depreciated is replaced, the remaining depreciation becomes a current deduction.

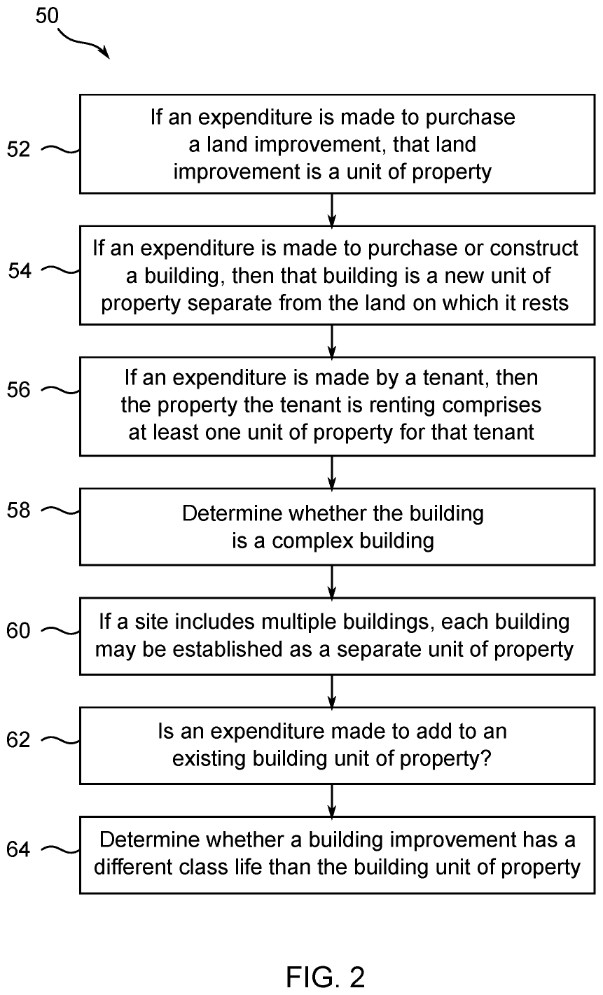

FIG. 2 illustrates an embodiment of a flowchart for determination of units of property 50, which may be used at 16 of the method 10. At 52, if an expenditure is made to purchase land improvements, those land improvements are a unit of property. At 54, if an expenditure is made to purchase or construct a building, then that building is a new unit of property separate from the land improvement unit of property on which the building rests or is to rest.

At 56, if the expenditure is made by a tenant, then the property the tenant is renting comprises at least one unit of property for that tenant. Thus, in a building having a number of tenants that are expending money on their leaseholds, each unit rented by each tenant may be a unit of property.

At 58, a determination is made as to whether the building is a complex building. For example, if two or more building portions share a wall, those portions may constitute a single complex building. Thus, a condominium or cooperative could be a single unit of property. When condominium or cooperative units are separately owned, however, each separately owned unit may constitute a separate unit of property. At 60, if a site includes multiple buildings, such as a multi-building condominium or cooperative, each building may be established as a separate unit of property. Each unit of property may stand separate from other units of property when determination is made regarding expenditures for that unit or property.

At 62, if an expenditure is made to add to an existing building unit of property, a determination is made at 64 as to whether the building addition has changed the class life of the property. If the building addition has changed the class life of the property, then the addition created by the expenditure is a unit of property separate from the unimproved property.

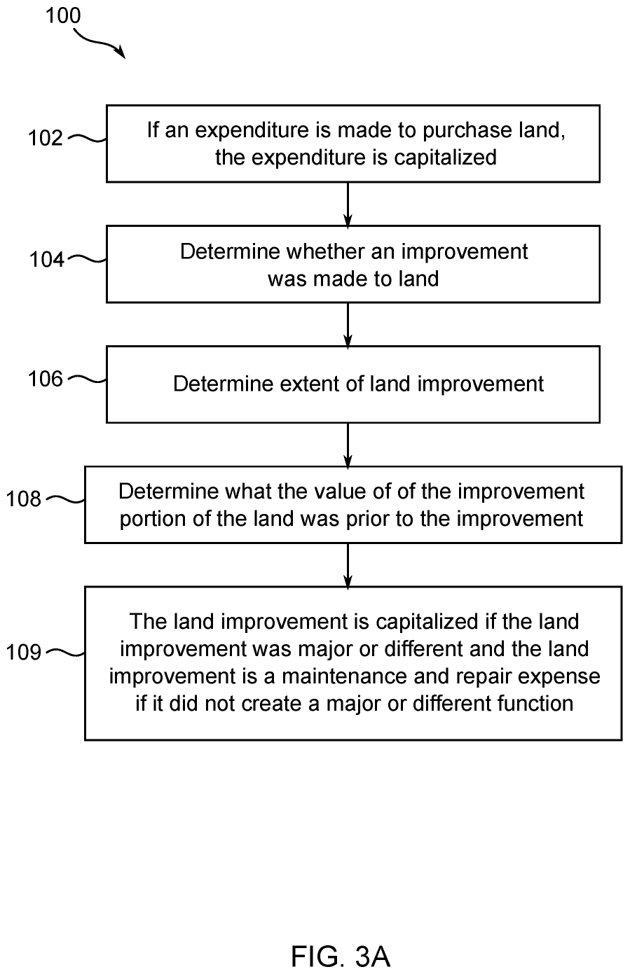

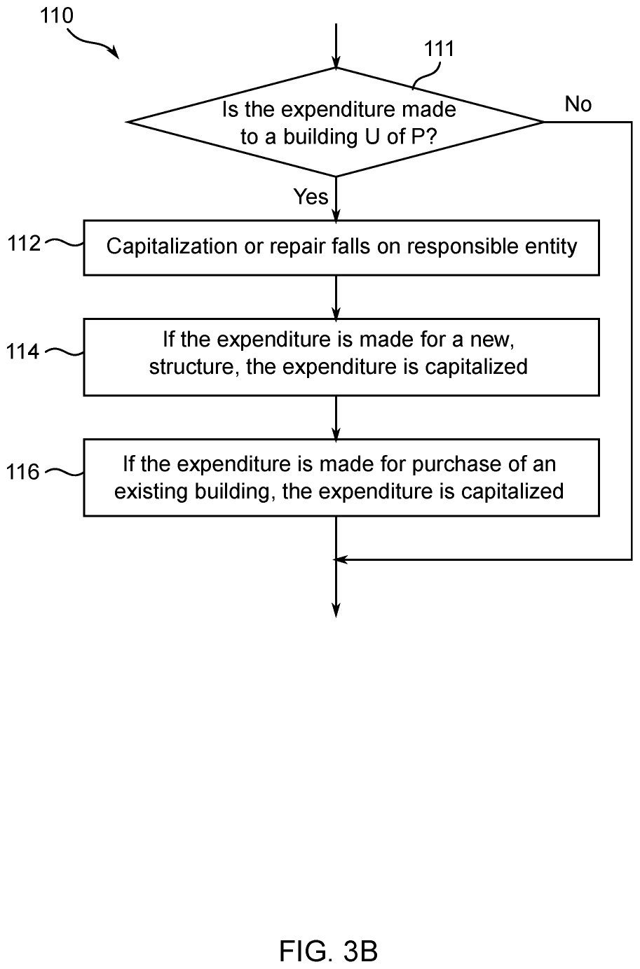

FIG. 3a is a flowchart of a method 100 that may be used in method 10 at 22 for determining whether an expenditure made on a land improvement is a capital expenditure or a maintenance and repair expenditure. At 102, if the expenditure is made to purchase land, the expenditure is capitalized. At 104, a determination is made as to whether an improvement was made to land improvement. At 106, the extent of the land improvement is determined. At 108, a determination is made as to what the value of the improvement portion of the land improvement was prior to the improvement. At 109 the land improvement is capitalized if the land improvement was major or different and the land improvement is classified as maintenance and repair expense if it did not create a major or different function.

FIG. 3b is a flowchart of a method 110 that may be used in method 10 at 22 for determining whether an expenditure made on a building is a capital expenditure or a maintenance and repair expenditure. At 111, a determination is made as to whether the property in question is a building. If the property is a building, then at 112 if the expenditure is made on the building by a tenant and is a construction allowance provided to the tenant by the owner of the building, with no construction accounting or responsibility back to the landlord, the expenditure capitalization is determined by the tenant. If construction accounting or responsibility is the landlord's responsibility, the expenditure capitalization is determined by the landlord. At 114, if the property is a building and the expenditure is made for a new structure, the expenditure is capitalized. At 116, if the property is a building and the expenditure is made for purchase of an existing building, the expenditure is capitalized. If the current expenditure is for an improvement to an existing structure that has not recently been purchased, the determination of whether the expenditure is a capital expenditure, which may, for example, be determined at 24 in FIG. 1.

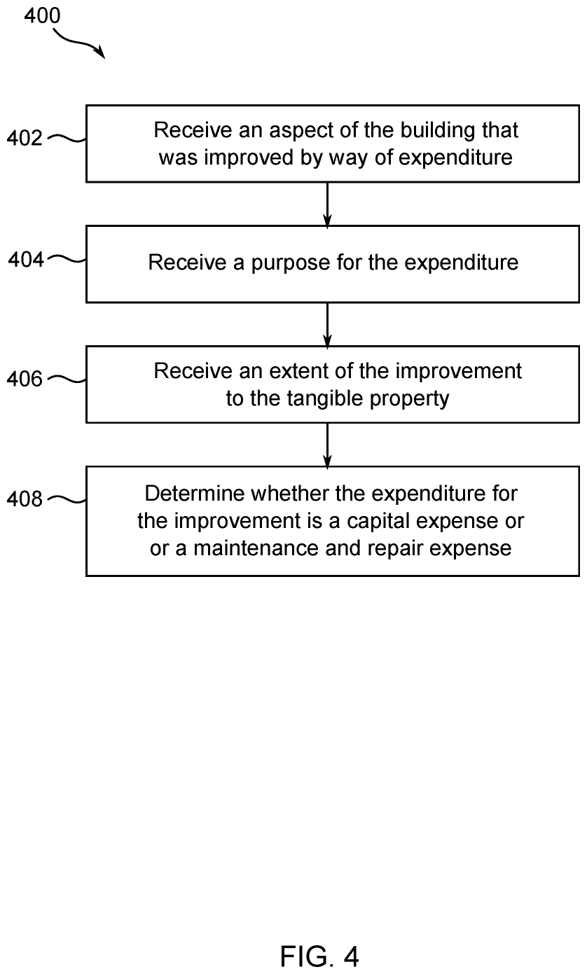

FIG. 4 illustrates an embodiment of a tangible property expenditure classification system that determines whether a building or land improvement is a capital expenditure or a maintenance and repair expenditure 400. The tangible property expenditure classification system 400 may include a computerized system, for example in one embodiment the computerized system 600 provided and discussed below with respect to FIG. 6 or another computerized system. The computerized system 600 may include or operate with a network, such as the network 750 discussed below with respect to FIG. 7 in an embodiment.

Thus, for example, the system 600 may be embodied in the tangible property expenditure classification system 400 by way of a processor 604 that executes instructions which, when executed by the processor 604, cause the processor 604 to perform the functions discussed herein with respect to FIG. 4. A data storage device 606 may be coupled to the processor 604 and may store data input or otherwise provided during the execution of those functions, for example, data related to tangible property, expenditures for the tangible property, and whether the tangible property expenditure is an expense or capital expenditure. The data storage device 606 may also store the data on which the determination of whether the tangible property expenditure is an expense or capital expenditure is based. Recorded and evaluated information such as tangible property information determined by the tangible property expenditure classification system 400 may be based on information entered into the computerized system 600 by one or more users.

In the system 400, a determination is made by the system 400 as to whether the expenditure, which may be recorded based on user input or entry into the system 600, for example, ameliorated or improved a prior material condition. A prior material condition may include any fact that may have a significant and reasonable impact on the market value of the property and may include, for example, structural defects, working condition of appliances, and fixtures, systems or equipment in need of repair.

The tangible property expenditure classification system 400 may receive, from a user for example, the aspect of the building that was improved by way of the expenditure at 402. The tangible property expenditure classification system 400 may also receive a purpose for the expenditure, such as for example, correction of an existing material condition or to improve a previously operational building system at 404. At 406, the tangible property expenditure classification system 400 may receive an extent of the improvement to the tangible property, for example, in terms of percent of a building system that was improved, number of units of improvement installed, area of improvement installed, or years of extended lifespan of the building system. At 408, the tangible property expenditure classification system 400 may determine whether the expenditure for the improvement was a capital expenditure or a maintenance and repair expense, based on the information obtained at 402, 404, and 406.

If the expenditure ameliorated or improved a prior existing material condition, then for building indoor improvements, building components, and building systems, a determination may be made by the system 400 at 408 as to whether the percent of the improved building attribute, which may be an entire system, a component, or a portion of a system, that was improved is greater than a policy factor, such as a percent above which capitalization is required and below which the expenditure may be considered maintenance or a repair. If the expenditure ameliorated or improved another type of prior existing material condition, then a determination may be made by the system 400 at 408 that the expenditure is a capital expense.

A capital expenditure may be depreciated over the useful life of the thing for which the expenditure was made, while maintenance or repairs may be expensed in a current year. In making this determination, the building attribute that was improved and parameters of the attribute, such as a description of the attribute, number of attribute items, or an amount related to the attribute may have been entered into the system 400 at by one or more users at 402, 404, or 406.

Thus, in an embodiment, the tangible property expenditure classification system 400 at 402 may permit selection by the one or more users of the type of building improvement from a listing, such as, for example, the following list:

Roof;

Windows;

Doors;

Floors;

Outside building envelope and type (e.g., siding, brick, stone);

Skylights;

Heating, ventilating, and air conditioning system;

Electrical system;

Natural gas distribution system;

Fire suppression system;

Security system;

Fire alarm system;

Elevators;

Escalators;

Plumbing;

Other building system;

Ancillary items not related to building components or systems; and

Land improvements.

The tangible property expenditure classification system 400 at 404 may permit selection by the one or more users of the purpose of the improvement from a listing, such as, for example, the following list:

Increase in efficiency;

Increase in capacity;

Increase in number of the attributes in building (such as elevators, escalators, bathrooms, etc.); or

Increase in the percentage of the attribute in building (such as lighting fixtures, cooling capacity, sewerage, etc.).

The purpose of the improvement provided at 404 may include for land improvement whether and to what extent there is change to the functionality of the land due to the improvement.

The tangible property expenditure classification system 400 may also, at 406, permit classification of the expenditure as less than, equal to, or greater than a preexisting amount of the attribute improved, a predetermined amount of the attribute, or a predetermined value associated with the attribute. At 406, the predetermined amount or value of the attribute may be recorded, and the system 400 may calculate the percent of the amount of the attribute improved based on expenditure or other attribute. Alternately or in addition, the tangible property expenditure classification system 400 may at 406 permit entry or selection by one or more users of a percent improvement to the attribute.

At 408, the tangible property expenditure classification system 400 may calculate whether the improvement is a capital expense or a maintenance and repair expense. In an embodiment, the system 400 at 408 determines whether the percent of the improved building attribute determined at 406 is greater than the percent at which capitalization is required. If so, the system 400 at 408 may determine that the improvement is a capital expenditure. If not, the system 400 at 408 may determine that the improvement is a repair and maintenance expenditure.

The tangible property expenditure classification system 400 may be repeated by the system 600 for each of multiple improvements made to tangible property if desired.

Thus, for example, if an expenditure is made on a roof improvement, the user may at 402 enter the type of roof improvement made (e.g., rubber membrane roofing is installed, elastomeric coating is applied to the roof, or shingles are replaced). The user may also enter at 406 the amount of existing roofing that was retained and the amount of new roofing that was installed by, for example, square foot. The tangible property expenditure classification system 400 may then determine at 408 whether the expenditure is to be classified as a repair or improvement based on the type of improvement made and the amount of the improvement in relation to the amount of the attribute that exists on the unit of property.

If, for example, a building is expanded such that the total space of the building has been increased, the user may at 406 enter the quantity of space that existed in the building prior to the expansion and the quantity of space that exists in the building after the expansion (e.g., in square feet). The tangible property expenditure classification system 400 may then determine at 406 the change in space created by the expansion.

The tangible property expenditure classification system 400 may then classify at 408 the expansion as either maintenance and repair or a capital expenditure. For example, if the building contained less than one hundred thousand square feet (100,000 ft²) and the expansion added less than five percent (5%), the expansion tangible property expenditure classification system 400 may classify that expenditure as maintenance and repair. Conversely, if the building contained less than one hundred thousand square feet (100,000 ft²) and the expansion added more than five percent (5000 ft²), the expansion tangible property expenditure classification system 400 may classify that expenditure as a capital expenditure.

In another example, the tangible property expenditure classification system 400 may classify at 408 an expenditure in a building that contained more than one hundred thousand square feet (100,000 ft²) and less than five hundred thousand square feet (500,000 ft²) having less than a three percent (3%) expansion as repair and maintenance. Conversely, in a building that contained more than one hundred thousand square feet (100,000 ft²) and less than five hundred thousand square feet (500,000 ft²), having a greater than three percent (3%) expansion may be classified at 408 as a capital expenditure.

In yet another example, the tangible property expenditure classification system 400 may classify at 408 an expenditure in a building that contained more than five hundred thousand square feet (500,000 ft²) and having an expansion of less than a one and one-half percent (1½%) of the building space as repair and maintenance. Conversely, in a building that contained more than five hundred thousand square feet (500,000 ft²), the tangible property expenditure classification system 400 at 408 may classify an expansion of greater than one and one-half percent (1½%) as a capital expenditure.

The amounts and percentages provided in those examples are in themselves examples and another desired amount or percentage can replace any amount or percentage in those examples to suit the user or facts and circumstances.

If an improvement for which an expenditure was made is related to a heating, ventilating, or air conditioning (HVAC) system as provided by a user at 402, the tangible property expenditure classification system 400 may request, such as at 404, that the user enter whether the improvement improved the efficiency of the HVAC system. If the improvement improved the efficiency of the HVAC system or aspect (e.g., heating or cooling) thereof, the tangible property expenditure classification system 400 may request at 406 that the user enter the percent improvement realized or expected to be realized from the improvement. If the improvement to the HVAC system or an aspect of the HVAC system is greater than a predetermined percent, such as ten percent (10%), the tangible property expenditure classification system 400 may determine at 408 that the expenditure is a capital expenditure. If the improvement to the HVAC system or an aspect of the HVAC system is less than the predetermined percent, the tangible property expenditure classification system 400 may determine at 408 that the expenditure qualifies as maintenance or a repair.

If an improvement for which an expenditure was made is related to a heating, ventilating, or air conditioning (HVAC) system, the tangible property expenditure classification system 400 may request at 404 that the user enter into the system 600 whether the improvement increased the capacity of the HVAC system. If the improvement increased the capacity of the HVAC system or aspect thereof, the tangible property expenditure classification system 400 may request at 406 that the user enter into the system 600 the percent increase in capacity realized or expected to be realized from the improvement. If the capacity of the HVAC system or an aspect of the HVAC system is increased more than a predetermined percent, such as fifteen percent (15%), the tangible property expenditure classification system 400 at 408 may determine that the expenditure is a capital expenditure. If the capacity of the HVAC system or an aspect of the HVAC system is increased less than the predetermined percent, the tangible property expenditure classification system 400 at 408 may determine that the expenditure qualifies as maintenance or a repair.

For example, where an HVAC improvement expenditure was made, the tangible property expenditure classification system 400 may request at 404 that the user enter into the system 600 the number of HVAC units replaced or the HVAC tonnage or BTU capacity that was replaced. If the improvement increased the capacity or units of the HVAC system or a portion of the HVAC system, the tangible property expenditure classification system 400 may request at 406 that the user enter into the system 600 the amount of the tonnage or units replaced. If the amount of the tonnage or units replaced of the HVAC system is more than a predetermined percent, such as thirty-five percent (35%), the tangible property expenditure classification system 400 at 408 may determine that the expenditure is a capital expenditure. If the capacity of the HVAC system or an aspect of the HVAC system is increased less than the predetermined percent, the tangible property expenditure classification system 400 at 408 may determine that the expenditure qualifies as maintenance or a repair.

If the improvement was to HVAC controls and increased efficiency or capacity, the same metrics and methods used hereinabove, applied to the HVAC control system rather than an HVAC system, may be employed to determine whether the expenditure for those controls was a capital improvement or a maintenance and repair expenditure.

If an improvement for which an expenditure was made is related to a roof or roofing system such as provided by a user at 402, the tangible property expenditure classification system 400 may request at 406 that the user enter the amount of the roof covered by the improvement (e.g., in ft²). If the improvement covered more than a predetermined portion of the roof, for example thirty percent (30%) of the roof, the tangible property expenditure classification system 400 may determine at 408 that the expenditure is a capital expenditure. If the improvement to the roof covers less than the predetermined portion of the roof, the tangible property expenditure classification system 400 may determine at 408 that the expenditure qualifies as maintenance or a repair.

In addition, where an expenditure is related to a roof or roofing system, the tangible property expenditure classification system 400 may request at 406 that the user enter the expected increase in the lifespan of the roof due to the improvement. If the roofing system increased the expected lifespan of the roof by more than a predetermined amount of time over the expected lifespan of the roof prior to the improvement, for example thirty percent (30%), the tangible property expenditure classification system 400 may determine at 408 that the expenditure is a capital expenditure. If the improvement to the roofing system increased the expected lifespan of the roof by less than that predetermined amount of time over the expected lifespan of the roof prior to the improvement, the tangible property expenditure classification system 400 may determine at 408 that the expenditure qualifies as maintenance or a repair.

If an improvement for which an expenditure was made is related to the addition of new skylights as provided at 402, the tangible property expenditure classification system 400 may request that the user enter, such as at 406, the number of skylights that existed in that unit of property before the addition of new skylights and the number of new skylights added. Alternately, the tangible property expenditure classification system 400 may request at 406 that the user enter the area of the skylights that existed in that unit of property before the addition of new skylights and the area of new skylights added. If the increase in the number or area of skylights exceeds a predetermined percentage, for example thirty percent (30%), the tangible property expenditure classification system 400 may determine at 408 that the expenditure is a capital expenditure. If the increase in the number or area of skylights is less than the predetermined percentage, the tangible property expenditure classification system 400 may determine at 408 that the expenditure qualifies as maintenance or a repair.

If an expense for an improvement for roof security, burglar deterrence, or burglar deterring bars is entered into the tangible property expenditure classification system 400, such as by a user at 404, the tangible property expenditure classification system 400 may classify that expense at 408 as one made for maintenance and/or repair.

If an HVAC improvement was performed on a roof as provided at 402, then the tangible property expenditure classification system 400 may at 408 combine the entire roof alteration into a single improvement and determine whether to classify the expenditure as a capital expenditure or maintenance and repair expense based on the improved efficiency or capacity of the HVAC system or the extent of the improvement to the overall building, such as provided by the user at 406.

If an improvement for which an expenditure was made is related to an electrical system such as provided by a user at 402, the tangible property expenditure classification system 400 may request that the user enter at 404 whether the improvement improved the efficiency of the electrical system. If the improvement improved the efficiency of the electrical system, the tangible property expenditure classification system 400 may request at 406 that the user enter the percent improvement realized or expected to be realized from the improvement. If the improvement to the electrical system or an aspect of the electrical system is greater than a predetermined percent, such as thirty percent (30%), the tangible property expenditure classification system 400 may determine at 408 that the expenditure is a capital expenditure. If the improvement to the electrical system or an aspect of the electrical system is less than the predetermined percent, the tangible property expenditure classification system 400 may determine at 408 that the expenditure qualifies as maintenance or a repair.

For an electrical system upgrade, the tangible property expenditure classification system 400 may next request, at 402, that the user input whether lights were added. If lights were added, the tangible property expenditure classification system 400 may ask at 402 whether those lights were interior to the unit of property or exterior to the unit of property being examined.

If the added lights were exterior, the tangible property expenditure classification system 400 may ask, such as at 404, whether those lights were added for a specific business purpose. The tangible property expenditure classification system 400 may also ask, for example at 402, whether those lights were added to an existing lighting system or if they comprised a new lighting system. If the added lights are exterior to the unit of property, were for a specific business purpose, and comprised a new system, then the tangible property expenditure classification system 400 may determine at 408 that the new lights comprise a new unit of property, and render the lights a capital expenditure.

The tangible property expenditure classification system 400 may ask, such as at 404, whether the lighting expenditure was due to the need of a particular tenant. If the lighting expenditure for new lights was due to the need of a particular tenant, then the tangible property expenditure classification system 400 may determine at 408 that that expenditure created a new unit of property, and render the lights a capital expenditure.

If the added lights were not exterior to the unit of property, were not for a specific business purpose, or did not create a new lighting system, as clarified by the user at 402, then the tangible property expenditure classification system 400 may determine, such as at 408, that the new lights do not comprise a new unit of property and may continue to determine whether the expenditure for the new lights is a capital expense or is maintenance and repair. If an expenditure was made for additional lights that do not create a new unit of property, the tangible property expenditure classification system 400 may return to 404 and request that the user enter whether the improvement increased the capacity of an existing lighting system. If the improvement increased the capacity of the existing lighting system, the tangible property expenditure classification system 400 may request at 406 that the user enter the percent increase in capacity realized or expected to be realized from the added lights. The system 400 may determine increased capacity in terms of lighting fixtures, lumens of capacity, or another lighting metric desired by the user. If the capacity of the lighting system was increased more than a predetermined percent, such as thirty percent (30%), the tangible property expenditure classification system 400 may determine at 408 that the expenditure is a capital expenditure.

If the lighting expenditure was to convert at least a predetermined amount, such as thirty percent (30%), of the building lighting system to light emitting diode (LED) lighting, then at 408 the expenditure may be capitalized.

If the lighting expenditure was to increase the number of transformers in the building at least a predetermined amount, such as thirty percent (30%), then at 408 the expenditure may be capitalized.

If the lighting expenditure was to sub-meter at least a predetermined amount, such as thirty percent (30%), of the building, then at 408 the expenditure may be capitalized.

If the addition to the lighting system does not qualify as a capital expenditure, then the tangible property expenditure classification system 400 may determine at 408 that the expenditure qualifies as maintenance or a repair.

The tangible property expenditure classification system 400 may request at 402 whether the improvement was to a natural gas distribution system. If a gas distribution system was installed and it was installed for a tenant, then the tangible property expenditure classification system 400 may create at 408 a new unit of property for that gas distribution system, and render the improvement a capital expense.

The tangible property expenditure classification system 400 may request at 406 that the user enter whether the gas distribution expenditure was to sub-meter at least a predetermined amount, such as thirty percent (30%), of the building. If so, then at 408 the expenditure may be capitalized.

The tangible property expenditure classification system 400 may request at 404 that the user enter whether the gas distribution expenditure was part of an HVAC system improvement and the HVAC system expenditure was a capital expenditure. If so, then the tangible property expenditure classification system 400 may determine at 408 that the expenditure may be capitalized.

If a gas distribution system did not create a new unit of property and was not to sub-meter greater than the predetermined amount of the building, the tangible property expenditure classification system 400 may request at 402 whether the gas distribution system was a new system installed where none existed before. If the gas distribution system is such a new system and not an improvement to an existing system, the tangible property expenditure classification system 400 may determine at 408 that the expense associated with installing that new gas distribution system was a capital expenditure.

If an improvement for which an expenditure was made is related to a gas distribution system, as may have been provided by a user at 402, the tangible property expenditure classification system 400 may request at 404 that the user enter whether the improvement expanded the scope of an existing gas distribution system. If the improvement did expand the scope of the existing gas distribution system, the tangible property expenditure classification system 400 may request at 406 that the user enter the percent the gas distribution system was expanded by the work for which the expenditure was made. If the gas distribution system was expanded by more than a predetermined percent, such as thirty percent (30%), the tangible property expenditure classification system 400 may determine at 408 that the expenditure for that expansion is a capital expenditure. If the gas distribution system was expanded by less than the predetermined percent, the tangible property expenditure classification system 400 may determine at 408 that the expenditure qualifies as maintenance or a repair.

If an improvement for which an expenditure was made is related to the addition of new windows or doors, as may have been provided at 402 by one or more users, the tangible property expenditure classification system 400 may request at 406 that the user enter the number of windows or doors that existed in that unit of property before the addition of new windows or doors and the number of new windows or doors added. Alternately, the tangible property expenditure classification system 400 may request at 406 that the user enter the area of the windows or doors that existed in that unit of property before the addition of new windows or doors and the area of new windows or doors added. If the increase in the number or area of windows or doors exceeds a predetermined percentage, for example thirty percent (30%), the tangible property expenditure classification system 400 at 408 may determine that the expenditure is a capital expenditure. Doors in this examination may include man doors, garage doors, loading doors and any other type of doors.

If the added doors or windows increased the efficiency of the unit of property by more than a predetermined percentage, for example thirty percent (30%), the tangible property expenditure classification system 400 may determine at 408 that the expenditure is a capital expenditure.

If the increase in the number or area of windows or doors is less than the predetermined percentage and the increase in efficiency of the new windows or doors is not more than the predetermined percentage, the tangible property expenditure classification system 400 may determine at 408 that the expenditure qualifies as maintenance or a repair.

If an improvement for which an expenditure was made is related to the addition of new cabinetry, carpet, equipment, or one or more appliances, as may have been provided at 402 by one or more users, the tangible property expenditure classification system 400 may request at 406 that the user enter how much or the number of units that existed in that unit of property before the addition of new cabinetry, carpet, equipment, or appliances and the number of new cabinetry, carpet, equipment, or appliances added. Cabinets that are connected together may be considered a single unit and may be measured in terms of their length or another metric other than a number of cabinets. Moreover, appliances are treated the same regardless of whether they are plugged into an outlet or wired directly to electrical power. Each appliance may be classified as a separate unit of property, including, for example, a refrigerator or dishwasher. Expenditure related to equipment may be classified as a separate unit of property if the expenditure is for equipment that is able to function on its own, and is not part of a network of equipment. If the increase in the number, efficiency, or area of cabinetry, carpet, or equipment exceeds a predetermined percentage, for example thirty percent (30%), the tangible property expenditure classification system 400 at 408 may determine that the expenditure is a capital expenditure. If the increase in the number, efficiency, or area of cabinetry, carpet, or equipment is less than the predetermined percentage, the tangible property expenditure classification system 400 may determine at 408 that the expenditure qualifies as maintenance or a repair.

The tangible property expenditure classification system 400 may request at 402 that a user enter into the system 400 whether the expenditure resulted in a land improvement. The tangible property expenditure classification system 400 may furthermore at 402 inform the user that a land improvement may include, for example, placement of asphalt, concrete, a fence, a gate, a trash enclosure, or landscaping. If the result of the expenditure was a land improvement, the tangible property expenditure classification system 400 may ask at 404 the user to input whether the land improvement created a major or different function to the land. If the land improvement was major or different, the tangible property expenditure classification system 400 at 408 may determine that the expense incurred in creating the improvement was a capital expense, while if the land improvement did not create a major or different function, the tangible property expenditure classification system 400 at 408 may determine that the expense incurred in creating the improvement was a maintenance and repair expense.

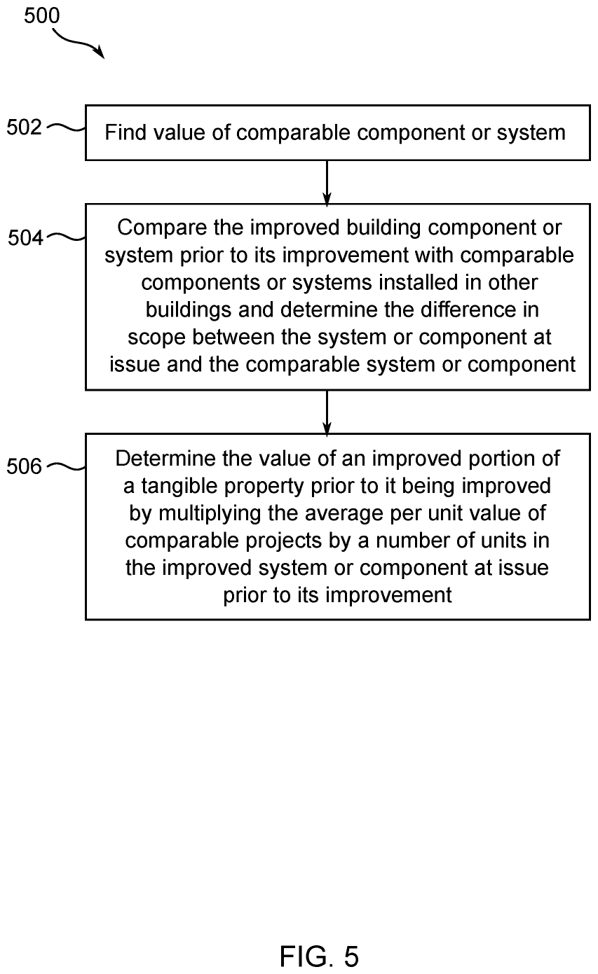

FIG. 5 illustrates an embodiment of a tangible property expenditure classification method 500 or part thereof that determines a value of the improved portion of the property prior to the improvement by accessing values of similar properties in the building market in which the unit of property stands. The method 500, which in an embodiment may be performed by the computerized system 600 described herein and may operate with the network 750 of FIG. 7, may be, if desired, incorporated into the method 10 described herein to determine the prior value of the property in the classification of a tangible property expenditure method 10 at 22 and, such as described herein with respect to FIGS. 1 and 3.

In the embodiment illustrated in FIG. 5, a tangible property expenditure method 500 for finding the value of an improved portion of a tangible property prior to the time when the improvement was made is provided. At 502, the tangible property expenditure method 500 finds the value of at least one comparable component or system. That value may be the cost of work performed on the comparable component or system may have been performed on a comparable property. The comparable property may be determined based on standard comparable property determination and may be a property in the geographic area of the property under determination with a similar building system or component installed in the recent past.

Comparable property determination is an industry standard and includes factors such as condition of sale (was the sale of the property an arms-length transaction), financing conditions, market conditions at the time of sale, locational comparability, and physical comparability of the properties. Comparable systems or components may include such factors as does the property have a similar building system or component and were the properties physically comparable, along with other factors including the other factors used in a comparable property determination. Thus, in one calculation, a building may be determined to be comparable because it is of the same class as the building at issue and is proximate to the building at issue and had a large scale replacement of the same system in the last two years. Moreover, more than one building market may be applicable to a building, for example, where a building is proximate to more than one building market or is of a type that would benefit statistically from a broader building market definition because, for example, the building is not a type that is common in the nearest geographic building market.

Determining the difference in scope between the present improvement and the similar improvements made to other buildings in the one or more building markets being considered may be accomplished by determining the per unit value of the comparable projects. Thus, at 504, the tangible property expenditure method 500 may compare the improved building component or system prior to its improvement with comparable components or systems installed in other buildings and determine the difference in scope between the system or component at issue and the comparable system or component at 502. The tangible property expenditure method 500 may determine the difference in scope between the building system or component at issue prior to its improvement and the comparable building systems or components by determining a per unit value of the comparable systems or components.

For example, finding the value of one or more similar components or systems on a property in the class of the present improvement in the building market may be performed by determining the amount spent on each project of that type performed on other buildings in the building market and dividing that amount by, for example, the area of the component improved or the size of the system improved to arrive at a per unit value of the work to determine the per unit value of the work on each comparable property.

Costs of work on buildings of the same class in the same building market may be found, for example, by compiling winning bid amounts for each such projects. Those winning bid costs may be compiled from public bids or private bids, for example. Those costs may then be used at to determine, at 504, the per unit cost of similar work to that of the improvement at issue.

The area of the component improved may, for example, be the area of a roof, foundation or floor replaced, whether partial or complete, in square feet, square meters, or another desired unit of measure. Window per unit value may be based on window count, window area, or a combination of those and other window related quantities or features.

System per unit values such as calculated at 504 may be determined, for example, by dividing the cost of a cooling system by the tonnage of the cooling equipment, dividing the cost of an escalator or elevator system by the number of escalators or elevators involved in the project and dividing that quotient by a factor related to the number of floors served by those elevators or escalators and other factors if desired. Other system per unit values may be determined by dividing an electrical system cost by the area served by the new electrical system or the amperage of the new electrical system or by dividing the cost of a piping system by the area served by that piping system or the length of pipe provided in that system, for example.

At 506, the tangible property expenditure method 500 may determine the value of an improved portion of a tangible property prior to it being improved by multiplying the average per unit value of comparable projects by a number of units in the improved system or component at issue prior to its improvement. The comparable value of the pre-improved portion of the tangible property to the value of the improvement may then be calculated and entered at, for example 406 of the tangible property expenditure classification system 400.

Thus, for example, at 506, project scope may be equalized by multiplying the per-unit cost of other projects by the number of units in the project in question. For example, the system 500 may divide the cost of one or more similar projects by the number of units in each of those one or more similar projects to arrive at a per-unit cost of such an improvement from the one or more similar improvements. Then the number of units in the project in question may be multiplied by the per-unit cost of the other projects to determine the value of the improved portion of the property before it was improved. In that way, at 506 the difference in scope between the present project and the comparable building systems or components can be accounted for and the value of the improved portion may be determined.

When determining the value of the improved portion of a present project in the method 500 where there are multiple comparable projects in the desired building market, the one most similar comparable building system or component can be used, an average of a number of comparable building systems or components can be used, or another determination can be made regarding which comparable building system or component may be considered in valuing the current improvement.

Similar projects may be found, for example, by collecting information about public or private bids made on improvements.

That tangible property expenditure method 500 may apply to improvements where a building system or component is replaced as well as to improvements where a building system or component is expanded.

As discussed above, embodiments regarding a tangible property expenditure classification method, such as embodiments discussed with respect to methods 10, 400, and 500 may be embodied in and performed by a system, such as the computerized system 600 shown in FIG. 6. The computerized system 600 may thus be, or be incorporated in, a system for classifying tangible property expenditure. The computerized system 600 may include a memory 602, a processor 604, a storage device 606, a monitor 608, a keyboard and/or mouse 610, and a communication adaptor 612. Communication between the processor 604, the storage device 606, the monitor 608, the keyboard or mouse 610, and the communication adaptor 612 is accomplished by way of a communication bus 614.

It should be recognized that any or all of the components 602-612 of the computerized system 600 may be implemented in a single machine. For example, the memory 602 and processor 604 might be combined in a state machine or other hardware-based logic machine.

The memory 602 may, for example, include random access memory (RAM), dynamic RAM, and/or read only memory (ROM) (e.g., programmable ROM, erasable programmable ROM, or electronically erasable programmable ROM) and may store computer program instructions and information. The memory may furthermore be partitioned into sections including an operating system partition 616 in which operating system instructions are stored, a data partition 618 in which data is stored, and a tangible property classification partition 620 in which instructions for carrying out tangible property classification functions are stored. The tangible property classification partition 620 may store program instructions and allow execution by the processor 604 of the program instructions. The data partition 618 may furthermore store data such as text, drawings, attachments, and other information during the execution of the program instructions.

The processor 604 may execute the program instructions and process the data stored in the memory 602. In one embodiment, the instructions are stored in memory 602 in a compressed and/or encrypted format. As used herein, the phrase “executed by a processor” is intended to encompass instructions stored in a compressed and/or encrypted format, as well as instructions that may be compiled or installed by an installer before being executed by the processor 604.

The storage device 606 may, for example, be a magnetic disk (e.g., memory stick or hard drive), optical disk (e.g., CD-ROM) or any other device or signal that can store digital information including those maintained over the internet at a remote location. The communication adaptor 612 permits communication between the computerized system 600 and other devices or nodes coupled to the communication adaptor 612 at the communication adaptor port 624. The communication adaptor 612 may be a network interface that transfers information from nodes on a network to the imaging interface 601 or from the computerized system 600 to nodes on the network. The network may be a local or wide area network, such as, for example, the Internet, the World Wide Web. It should be recognized that the tangible property expenditure classification system 600 may alternately or in addition be coupled directly to one or more other devices through one or more input/output adaptors (not shown).

The computerized system 600 may also be generally coupled to output devices 608 such as, for example, a monitor 608 or printer (not shown), and various input devices such as, for example, a keyboard or mouse 610. Moreover, other components of tangible computerized system 600 may not be necessary for operation of the computerized system 600. For example, the storage device 606 may not be necessary for operation of the computerized system 600 as all information referred to by the computerized system 600 may, for example, be held in memory 602.

The elements 602, 604, 606, 608, 610, and 612 of the computerized system 600 may communicate by way of one or more communication busses 614. Those busses 614 may include, for example, a system bus, a peripheral component interface bus, and an industry standard architecture bus.

A network in which the computerized system 600 may be implemented may be a network of nodes such as computers, telephones, or other, typically processor-based, devices interconnected by one or more forms of communication media. The communication media coupling those devices may include, for example, twisted pair, co-axial cable, optical fibers, and wireless communication methods such as use of radio frequencies. A node operating in connection with or as a computerized system 600 may receive the data stream 652 from another node coupled to a Public Switched Telephone Network (PSTN), the Internet, a Local Area Network (LAN), a Wide Area Network (WAN), or another network.

Network nodes may be equipped with the appropriate hardware, software, or firmware necessary to communicate information in accordance with one or more protocols, wherein a protocol may comprise a set of instructions by which the information is communicated over the communications medium. For example, the OSI architecture, which includes a physical layer, a data link layer, a network layer, a transport layer, a session layer, a presentation layer, and an application layer, or a subset thereof may be used for network communication.

FIG. 7 illustrates an embodiment of a network 750 in which the computerized system 600 may operate. The network may include two or more nodes 754, 756, 758, 760 coupled to a network 752 such as a LAN, a WAN, the Internet, or a telephone network such as a PSTN.

The network 750 may include an innovation management node 754 receiving a data stream such as innovation information from a second node such as the nodes 756, 758, and 760 coupled to the network 752.

In an embodiment, a computerized system 600 includes a processor that executes instructions and thereby causes the processor to perform functions described herein.

In another embodiment, an article of manufacture includes a computer readable medium that includes instructions which, when executed by a processor, cause the processor to perform functions described herein with respect to an innovation management system.

In one embodiment, the innovation management system employs a computer program in a computerized system. A user may access the management system by executing the program through a computer or other system or device and viewing presentations of the executed program through a user interface.

In embodiments as provided above, the computerized system 600 performs the methods described herein, such as the tangible property expenditure classification methods 10, 400, and/or 500.

In an embodiment, the computerized system 600 may be a tangible property expenditure classification system 600, which may include the data storage device 606 to store data related to the tangible property, to store data related to an expenditure for the tangible property, to store data on real properties related to the tangible property and in the area of the tangible property, and to store a determination of whether the tangible property expenditure is an expense or a capital expenditure and data on which that determination of whether the tangible property expenditure is an expense or a capital expenditure is based. The processor 604 may be coupled to the data storage device 606 and include instructions which, when executed by the processor, cause the processor 604 to select from the captured data one of: a replacement performed on one of the real properties that is similar to a replacement performed on the tangible property; and a repair performed on one of the real properties being analyzed that is similar to a repair performed on the tangible property. The instructions may further cause the processor to determine a cost of the one of the similar replacement and the similar repair and scale the cost of the one of the similar replacement and the similar repair to a scope of work performed on the tangible property being analyzed to find one of a comparable repair cost and a comparable replacement cost. The instructions may also cause the processor to provide an output that indicates to a human user one of the comparable repair cost and the comparable replacement cost, store the one of the comparable repair cost and the comparable replacement cost in the data storage device 606, store the determination of whether the tangible property expenditure is an expense or a capital expenditure in the data storage device 606, and store the data on which the determination of whether the tangible property expenditure is an expense or a capital expenditure was based in the data storage device 606.

In an embodiment, the tangible property expenditure classification system 600 may further determine whether a new unit of property has been created. In this embodiment, the processor 604 further includes instructions which, when executed by the processor, cause the processor 604 to determine whether the improvement created by the expenditure has created a separate and new building, which forms a new unit of property; determine whether the improvement created by the expenditure is controlled by a different entity, which forms a new unit of property; determine whether the improvement created by the expenditure has changed the class life of the property, which forms a new unit of property; provide an output that indicates to a human user whether the tangible property expenditure created a new unit of property; store in the data storage device 606 whether the tangible property expenditure created a new unit of property; store the determination of whether the expenditure has created a new unit of property in the data storage device 606; and store the data on which the determination of whether the expenditure has created a new unit of property in the data storage device 606.

While the present invention has been disclosed with reference to certain embodiments, numerous modifications, alterations, and changes to the described embodiments are possible without departing from the scope of the present invention, as defined in the appended claims. Accordingly, it is intended that the present invention not be limited to the described embodiments, but that it have the full scope defined by the language of the following claims, and equivalents thereof.

What is claimed is:

1. A tangible property expenditure classification system, comprising:
a data storage device to store data related to a tangible property, to store data related to an expenditure for an improvement made to a portion of the tangible property, to store data related to at least one of a comparable building component and building system, to store a determination of which of an expense and a capital expenditure is an appropriate classification for the expenditure for the tangible property, and to store data on which that determination is based;
a processor coupled to the data storage device, the processor including instructions which, when executed by the processor, cause the processor to:
capture data related to at least one of a building component and a building system that is comparable to the improved portion for which the expenditure was made;
determine a value of one of the comparable building component and the comparable building system;
scale a scope of the at least one comparable building component and comparable building system to a scope of one of the building component and the building system prior to the expenditure for improvement of the tangible property;
determine the value of one of the building component and the building system for which the expenditure was made prior to the improvement being made;
provide an output representing the value of the improved portion prior to the expenditure being made to a human user;
store the value of the improved portion prior to the expenditure being made in the data storage device;
determine whether the improvement was a maintenance and repair expense or a capital expenditure based on the value of the improved portion before the expenditure was made and the value of the expenditure; and
store the determination of whether the tangible property expenditure is an expense or a capital expenditure in the data storage device.

2. The tangible property expenditure classification system of claim 1, wherein the tangible property expenditure is for a roof improvement.

3. The tangible property expenditure classification system of claim 2, wherein the tangible property expenditure is classified as a capital expenditure because the expenditure was greater than or equal to a predetermined percent of the value of the roof before the improvement was made.

4. The tangible property expenditure classification system of claim 3, wherein the tangible property expenditure is classified as an expense because the expenditure was less than the predetermined percent of the value of the roof before the improvement was made.

5. The tangible property expenditure classification system of claim 1, wherein the tangible property expenditure is for a building expansion.

6. The tangible property expenditure classification system of claim 5, wherein the tangible property expenditure is classified as a capital expenditure because the expenditure was greater than or equal to a predetermined percent of the value of the roof before the improvement was made.

7. The tangible property expenditure classification system of claim 6, wherein the tangible property expenditure is classified as an expense because the expenditure was less than the predetermined percent of the value of the roof before the improvement was made.

8. The tangible property expenditure classification system of claim 1, wherein the tangible property expenditure is related to an HVAC system.

9. The tangible property expenditure classification system of claim 1, wherein the tangible property expenditure is related to security of the tangible property.

10. The tangible property expenditure classification system of claim 1, wherein the tangible property expenditure is related to an electrical system.

11. The tangible property expenditure classification system of claim 1, wherein the tangible property expenditure is for improvement to a gas distribution system.

12. The tangible property expenditure classification system of claim 1, wherein the tangible property expenditure is related to at least one of new windows and doors.

13. The tangible property expenditure classification system of claim 1, wherein the tangible property expenditure results in land improvement.

14. The tangible property expenditure classification system of claim 1, the processor further including instructions which, when executed by the processor, cause the processor to determine the number of units of the property that make up the tangible property.

15. The tangible property expenditure classification system of claim 1, wherein the data captured on the at least one of the building components and at least one of the building systems that is comparable to the improved portion for which the expenditure was made is captured from a real property that is comparable to the tangible property that was improved.

16. The tangible property expenditure classification system of claim 1,
the processor further to determine whether, with respect to the tangible property, a new unit of property has been created by further including instructions which, when executed by the processor, cause the processor to:
determine whether the improvement created by the expenditure has created a separate and new building, which forms a new unit of property;
determine whether the improvement created by the expenditure is controlled by a different entity, which forms a new unit of property;
determine whether the improvement created by the expenditure has changed the class life of the property, which forms a new unit of property;
provide an output that indicates to a human user whether the tangible property expenditure created a new unit of property;
store in the data storage device whether the tangible property expenditure created a new unit of property; and
store the data on which the determination of whether the expenditure has created a new unit of property is based in the data storage device.

17. A tangible property expenditure classification system, comprising:
a scanner for capturing physical information related to a tangible property;
a data storage device to store the physical information related to the tangible property, to store the value of the improved portion of the building prior to the improvement being made, the value of the improvement made, and the determination of whether the tangible property expenditure is an expense or a capital expenditure;
a processor coupled to the data storage device, the processor including instructions which, when executed by the processor, cause the processor to:
receive the physical information related to the tangible property;
receive a value of the improved portion of the building prior to the improvement being made;
receive a value of the improvement made;
determine whether the improvement was a maintenance and repair expense or a capital expenditure based on the value of the improved portion of the building before the expenditure was made and the value of the improvement made; and
store the value of the improved portion of the building prior to the improvement being made, the value of the improvement made, and the determination of whether the tangible property expenditure is an expense or a capital expenditure in the data storage device.

18. The tangible property classification system of claim 17, wherein the physical information related to a tangible property is with regard to the improvement to the tangible property.

19. The tangible property expenditure classification system of claim 17, wherein the tangible property expenditure is classified as a capital expenditure because the value of the improvement made was greater than or equal to a predetermined percent of the value of the improved portion of the building prior to the improvement being made.

20. The tangible property expenditure classification system of claim 19, wherein the tangible property expenditure is classified as an expense because the value of the improvement made was less than the predetermined percent of the value of the improved portion of the building prior to the improvement being made.
